(19) United States
(12) Patent Application Publication
(10) Pub. No.: US 2016/0165066 A1
(43) Pub. Date: Jun. 9, 2016

(54) Method And Apparatus For Spectrum Sharing Among Operators

(71) Applicant: Alcatel-Lucent USA Inc., Murray Hill, NJ (US)

(72) Inventors: Kai Yang, Chatham, NJ (US); Doru Calin, Manalapan, NJ (US)

(73) Assignee: Alcatel-Lucent USA Inc., Murray Hill, NJ (US)

(21) Appl. No.: 14/563,170

(22) Filed: Dec. 8, 2014

(51) Int. Cl. H04M 15/00; H04L 12/923; H04W 28/20

(52) U.S. Cl. CPC H04M 15/46; H04M 15/50; H04M 15/51; H04W 28/20; H04L 47/762

(57) ABSTRACT

Various methods and devices are provided to address the need for improved spectrum sharing. In one method, a broker network receives (501) from each bidder network of a group of bidder networks, a request for a spectrum allocation. The broker network sends (502) to the group of bidder networks an indication of a price and receives (503) from each bidder network an indication of accepted bandwidth corresponding to the price. Until (504) a broker exit condition is satisfied, the broker network iteratively performs the following: generates (505) a new price from the current price, sends (506) an indication of the new price to the group of bidder networks, and receives (507) an indication of accepted bandwidth corresponding to the new price from each bidder network of the group of bidder networks.

### FIELD OF THE INVENTION

The present invention relates generally to communications and, in particular, to spectrum sharing across multiple wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

A heterogeneous network (HetNet) may use one or more of a macrocell, picocell, small cell, or femto cell to provide wireless coverage in an environment with various coverage zones, possibly ranging from an outdoor rural area to an indoor home, office building, or other hot spot area (such as a stadium). A HetNet can operate over many licensed or unlicensed frequency bands, running different physical/link layer protocols. How to allocate spectrum bandwidth among different operators is of great importance for the successful and reliable operation of a HetNet.

Traditionally, mobile network operators operated their wireless networks over non-overlapping frequency bands. While this approach works well for macro cellular networks, it may lead to poor spectrum usage for a heterogonous network. This is because a wireless access node such as a small cell base station typically covers only a small area. As a consequence, the traffic for different operators can, at times, be highly imbalanced, as shown in diagram 100 of FIG. 1. In this example, operator B needs to serve three mobile users simultaneously while operator A needs to serve only one. A small cell with many users, e.g, cell B (the cell operated by operator B), may provide a poor user experience. On the other hand, for a small cell that is less loaded, e.g., cell A (the cell operated by operator A), the wireless spectrum is under-utilized.

A macro cell typically covers a large geographical area. When the cell is only lightly loaded, it can lease part of its own spectrum to another small cell operator, i.e., a secondary mobile network operator (MNO). If the secondary MNO deploys multiple base stations (BSs) within the area, as shown in diagram 200 of FIG. 2, the same frequency band can be reused multiple times. In this scenario, leasing the spectrum to the secondary MNO results in a much higher spectrum utilization.

In another example, a dealer might purchase a chunk of frequency spectrum from the government at a wholesale price in order to lease it to multiple operators at a retail price. Such an approach could prevent one or two operators from monopolizing the spectrum market, create new business opportunities, and also ensure optimal pricing of the spectrum to limit wasting of the scarce spectrum resources. Thus, new solutions and techniques that enable such functionality or that address one or more of the issues described above would meet a need and advance wireless communications generally.

### BRIEF DESCRIPTION OF THE DRAWINGS

FIG. 1 is a depiction of a loading imbalance between different operators' cells.

FIG. 2 is a depiction of a primary mobile network operator (MNO) and example secondary MNOs.

FIG. 3 is a logic flow diagram of functionality performed in accordance with certain embodiments of the present invention.

FIG. 4 is a block diagram depiction of a network node in accordance with various embodiments of the present invention.

FIG. 5 is a logic flow diagram of functionality performed by a broker network in accordance with various embodiments of the present invention.

FIG. 6 is a logic flow diagram of functionality performed by a bidder network in accordance with various embodiments of the present invention.

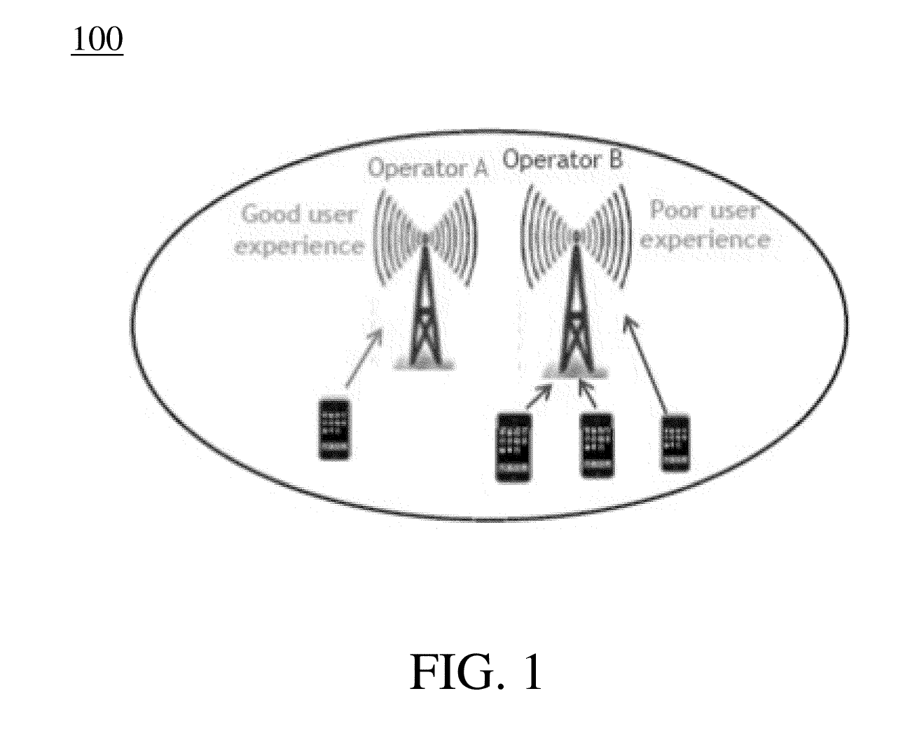

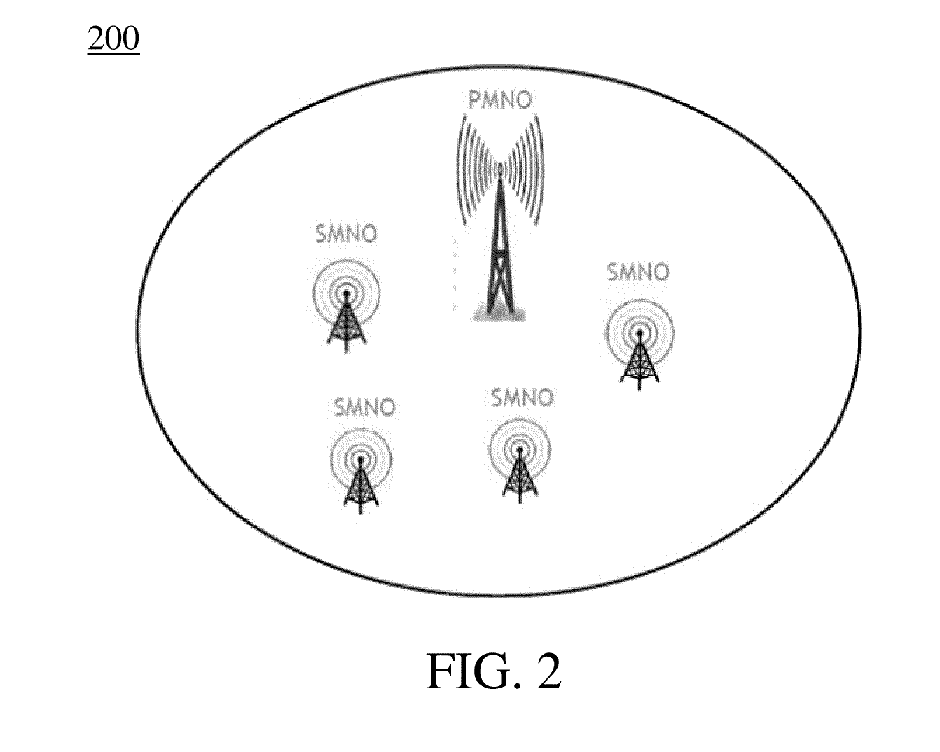

Specific embodiments of the present invention are disclosed below with reference to FIGS. 1-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address the need for improved spectrum sharing. In a first method, a broker network receives from each bidder network of a group of bidder networks, a request for a spectrum allocation. The broker network sends to the group of bidder networks an indication of a price and receives from each bidder network an indication of accepted bandwidth corresponding to the price. Until a broker exit condition is satisfied, the broker network iteratively performs the following: generates a new price from the current price, sends an indication of the new price to the group of bidder networks, and receives an indication of accepted bandwidth corresponding to the new price from each bidder network of the group of bidder networks. An article of manufacture is also provided, the article comprising a non-transitory, processor-readable storage medium storing one or more software programs which when executed by one or more processors performs the steps of this method.

Many embodiments are provided in which the first method is modified. For example, in many embodiments the broker exit condition is satisfied when the broker network determines that a broker utility function is sufficiently maximized, the broker utility function being a function of the accepted bandwidth as indicated by each bidder network of the group of bidder networks. Depending on the embodiment, the broker utility function may be set to total revenue generated. In many embodiments, the broker exit condition may additionally (or alternatively) be satisfied when the broker network determines that at least one of a threshold number of iterations has occurred or a threshold amount of time has elapsed. Also, in many embodiments, generating the new price from the current price involves calculating the new price using the current price, the accepted bandwidth as indicated by each bidder network of the group of bidder networks, a total amount of bandwidth available for bidding, and a step size. In some embodiments, the broker network adds an additional bidder network to the group of bidder networks, after beginning the iteration with the group of bidder networks.

In a second method, a bidder network sends to a broker network, a request for a spectrum allocation. Until a bidder exit condition is satisfied, the bidder network iteratively performs the following: receives an indication of a current price from the broker network, determines an amount of bandwidth that maximizes [value cost] to the bidder network given the current price, and sends an indication of the determined amount of bandwidth to the broker network. An article of manufacture is also provided, the article comprising a non-transitory, processor-readable storage medium storing one or more software programs which when executed by one or more processors performs the steps of this method.

Many embodiments are provided in which this method is modified. For example, in many embodiments the request for a spectrum allocation indicates an amount of bandwidth for which the bidder network desires to bid. Also in many embodiments, determining the amount of bandwidth that maximizes [value cost] to the bidder network given the current price involves using a utility function to calculate value, the utility function being a function of an amount of bandwidth. In some embodiments, using a utility function to calculate value may involve using a different utility function for some iterations than is used for other iterations. Also, in some embodiments, the bidder network may switch to a different utility function based on a traffic demand level at the bidder network.

A first network node apparatus is also provided. The first network node apparatus, being in a broker network, includes an interface unit, which includes a network interface for communication with other network devices, and a processing unit, communicatively coupled to the interface unit. The processing unit is configured to receive, via the interface unit from each bidder network of a group of bidder networks, a request for a spectrum allocation. The processing unit is also configured to send, to the group of bidder networks via the interface unit, an indication of a price and to receive, via the interface unit from each bidder network of the group of bidder networks, an indication of accepted bandwidth corresponding to the price. The processing unit is further configured to iteratively perform, until a broker exit condition is satisfied, the following: generating a new price from the current price, sending via the interface unit an indication of the new price to the group of bidder networks, and receiving via the interface unit an indication of accepted bandwidth corresponding to the new price from each bidder network of the group of bidder networks.

Many embodiments are provided in which this first network node is modified. For example, the network node may further include a wireless transceiver node, via which at least some of the communication with the group of bidder networks occurs. Additional examples of embodiments in which this first network node is modified can be found described above with respect to the first method.

A second network node apparatus is also provided. The second network node apparatus, being in a bidder network, includes an interface unit, which includes a network interface for communication with other network devices, and a processing unit, communicatively coupled to the interface unit. The processing unit is configured to send, to a broker network via the interface unit, a request for a spectrum allocation. The processing unit is further configured to iteratively perform, until a bidder exit condition is satisfied, the following: receiving an indication of a current price from the broker network via the interface unit, determining an amount of bandwidth that maximizes [value cost] to the bidder network given the current price, and sending an indication of the determined amount of bandwidth to the broker network via the interface unit.

Many embodiments are provided in which this second network node is modified. For example, the network node may further include a wireless transceiver node, via which at least some of the communication with the broker network occurs. Additional examples of embodiments in which this second network node is modified can be found described above with respect to the second method.

### DETAILED DESCRIPTION OF EMBODIMENTS

To provide a greater degree of detail in making and using various aspects of the present invention, a description of our approach to spectrum sharing and a description of certain, quite specific, embodiments follow for the sake of example. FIGS. 1-3 are referenced in an attempt to illustrate some examples of specific problems and specific embodiments of the present invention.

We propose a dual optimization mechanism to enable spectrum sharing among operators in a heterogeneous network. The spectrum sharing approach can optimally allocate the frequency bands to different operators such that a total utility function is maximized. Overall, this mechanism can provide a win-win solution for spectrum sharing among multiple operators. We describe some of the possible advantages of the proposed solutions below.

Spectrum sharing in a HetNet among different operators may not only provide an effective means to fully utilize the wireless spectrum, but it may also help operators generate extra revenue and find new business opportunities. The proposed dual optimization framework is quite general and can be applied to multiple scenarios. One important scenario of interest is to allow a primary MNO to lease its spare spectrum to secondary MNOs. For a primary operator, this mechanism allows it to obtain extra revenue by leasing spare spectrum to secondary MNOs. For secondary MNOs, this solution provides an incentive for the primary MNO to lease its spare spectrum to them in a fair way. Another important scenario of interest is to allow a spectrum broker to purchase a bulk of wireless spectrum and lease to MNOs. Such a pay-per-use business model avoids a spectrum monopoly and guarantees spectrum availability to secondary MNOs. For this scenario, the proposed framework can help the broker increase the profit and also promote competition in spectrum assignment so that efficient use of the radio spectrum is achieved. For brevity, spectrum broker and the primary MNO are used interchangeably hereafter. Likewise, we refer to secondary MNOs as spectrum bidders hereafter.

The proposed spectrum allocation algorithm proceeds iteratively and can be implemented in a fully distributive manner. For each iteration, the broker broadcasts a dual price to all bidders. Upon receiving this price information, every bidder calculates a tentative bandwidth allocation solution based on its own utility function and the price variable and then sends it back to the broker. Such a mechanism is fully distributed and the only information that is exchanged between the broker and the bidder is the price variable and the local spectrum allocation decision.

Depending on the embodiment, the message passing between the broker and the bidder can be implemented successively, in parallel, or in a hybrid manner. If the message passing is implemented successively, bidders calculate the bandwidth allocation decision in turn and then send it back to the broker. In the parallel updating approach, bidders calculate the bandwidth allocation decision in parallel based on the same price information. The hybrid algorithm combines both the successive and parallel updating strategies and thus allows flexible implementations.

Under mild conditions, the proposed spectrum allocation mechanism will converge to the optimal solution and can therefore maximize the utility function of the broker. If the utility function is set as the total revenue generated by leasing the spectrum to bidders, the broker can use this framework to achieve a maximum spectrum leasing profit, assuming the cost of spectrum leasing is fixed.

In some embodiments, the proposed strategy can update the spectrum allocation solution on-the-fly upon the admission of a new bidder. This can significantly enhance the convergence speed of the algorithm. In addition, during the updating process, the spectrum allocation solution at each step remains feasible. The broker does not need to be aware of the utility function of each bidder.

This protects the privacy of each bidder as the utility function may reveal its inherent business model. In addition, this allows each bidder to update its utility function dynamically (based on its traffic demand, for example) and avoids excessive message passing between the broker and bidders.

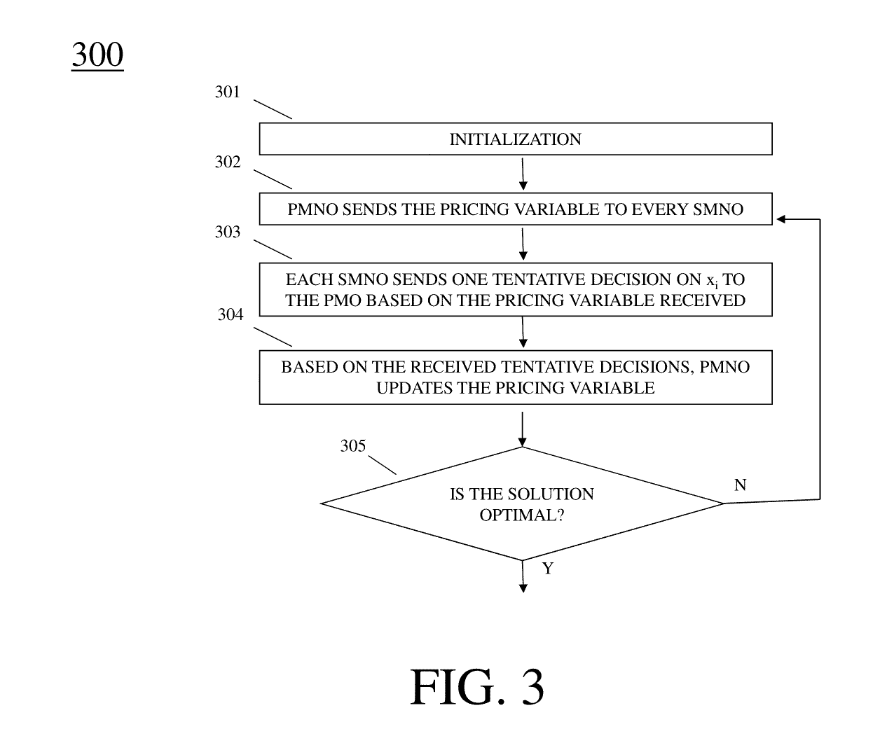

Certain embodiments of our approach are depicted in logic flow diagram 300 of FIG. 3. The broker (PMNO) is the one with spare bandwidth that can be shared with other MNOs. The bidders (SMNOs) are MNOs or mobile virtual network operators that lease spectrum from a broker for operation.

In general, the goal of this approach is to optimally allocate the resource (spectrum) across the different bidders. This optimization problem that the bidders and broker aim to solve can be expressed as the following

$$max {\sum }_{i} {U}_{i} ( {x}_{i} )$$

$$s . t . {\sum }_{i} {x}_{i} \leq B$$

xᵢ: The frequency bandwidth allocated to i-th SMNO

Uᵢ(xᵢ): The utility function of the i-th SMNO

B: The total bandwidth that the PMNO can share

At the initialization stage (301), the bidders each send a request to the broker for the amount of bandwidth desired. Each bidder sets an amount of bandwidth based on its need/desire and then sends it to the broker. Depending on the embodiment, such requests can be sent out via either wireless or wired channels. For example, in an LTE network, the spectrum allocation request among different eNodeBs can be communicated through X2 interfaces.

The proposed spectrum allocation strategy proceeds in an iterative manner. At the t^{th} iteration, the broker broadcasts (302) a price variable pₜ (i.e., a price per unit of spectrum) to all bidders. Using the price variable, each bidder calculates one tentative decision on the spectrum allocation by solving the following optimization problem

$$max {\sum }_{i} {U}_{i} ( {x}_{i} ) - {p}_{t} {x}_{i}$$

$$s . t {x}_{i} \geq 0$$

Let xᵢ^{t} denote the tentative solution (i.e., an amount of bandwidth) to the above problem at the t^{th} iteration. Then the bidder sends (303) xᵢ^{t} to the broker. Based on (304) the received tentative decision xᵢ^{t}, the broker determines whether the optimal solution has been achieved or whether an alternative exit condition has been triggered. For example, the broker may determine that the optimal solution has been achieved based on its utility function (total revenue, e.g.). Alternatively, the broker may determine that the number of iterations exceeds a pre-determined threshold. Each iteration requires computation by the broker and the bidder as well as communications between them. Since such communication and computation incur a time delay, the operator may set the threshold based on a delay constraint. For example, if the operator can allow 100 ms time delay and each iteration takes 1 ms, then the threshold could be set to 100. Alternatively, the broker may wish to exit the iterations simply after a threshold amount of time has elapsed, such as 100 ms.

Thus, if (305) an optimal solution has been achieved or an exit condition triggered, stop. Otherwise, the broker updates the price variable according to the following formula

Pₜ₊₁=Pₜ+aₜfₜ,

where aₜ is a step size and fₜ=Σᵢxᵢ^{t}−B, and then sends the updated price variable back to the bidder. In other words, the price at the (t+1)^{th} iteration (i.e., Pₜ₊₁) is a function of the price at the t^{th} iteration (i.e., Pₜ) and the tentative solution from all the bidders' t^{th} iteration (i.e., xᵢ^{t}) and the total bandwidth constraint B and some step size. The proposed algorithm is guaranteed to converge to an optimal solution as long as the step-size aₖ is chosen to be sufficiently small. See e.g., D. Bertsekas, Nonlinear Programming, Belmont, Mass.: Athena Scientific, 1999, pp 609-613. Classical step-size rules include a constant step size, i.e., aₜ=a, and square summable but not summable step size, i.e.,

$${a}_{t} \geq 0 , {\sum }_{t = 1}^{∞} {a}_{t}^{2} < ∞ , {\sum }_{t = 1}^{∞} {a}_{t} = ∞ .$$

Note that the only information exchanged between the broker and the bidders at the t^{th} iteration is the price variable Pₜ and xᵢ^{t}. This information exchange can be done successively, in parallel or a hybrid manner. In practice, the information exchanges can be done via any communication channel whether wireless or wireline.

Since the proposed strategy is of an iterative nature, it may take awhile to converge. Thus the local decision at t^{th} iteration may not be a feasible solution to the original problem, i.e., Σᵢxᵢ^{t}>B. This problem can be solved by calculating an auxiliary variable gₜ=B/Σᵢxᵢ^{t.} and set yᵢ^{t.}=gₜ xᵢ^{t.,}(if gₜ<1) as the spectrum allocation solution.

As described above, our spectrum sharing approach allows operators to dynamically share their wireless resources according to their utility functions. It is particularly suitable for heterogeneous networks in which each BS covers different geographical areas. Traditional wireless resource virtualization schemes are often of a heuristic nature and thus do not achieve an optimal solution. In contrast, the proposed solution is able to achieve an optimal solution to maximize spectrum usage, as measured by a network utility function. In addition, the proposed strategy is fully distributed with limited information exchange among operators and thus implementation friendly.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

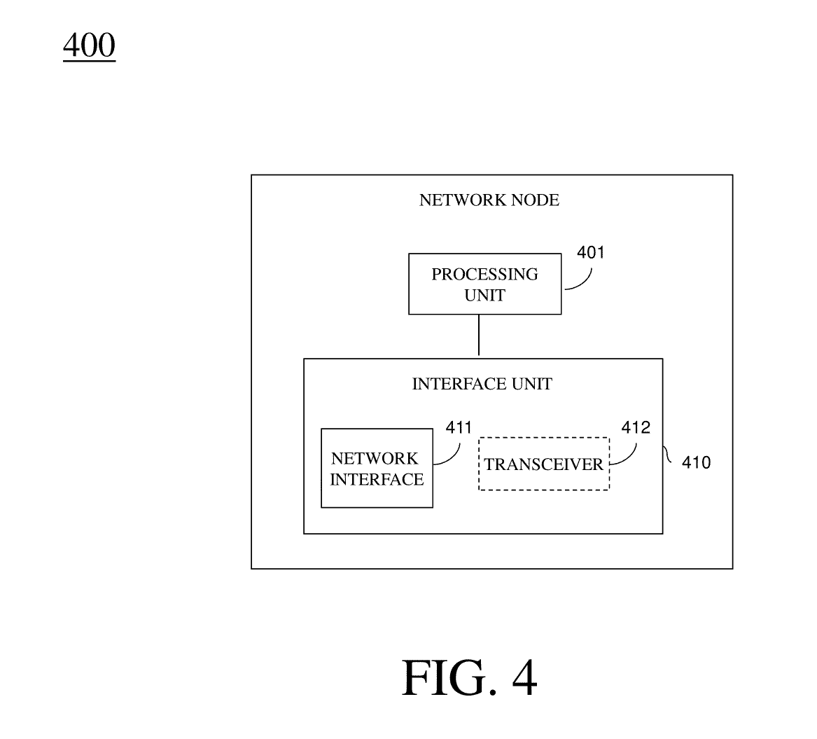

Having described certain embodiments in detail above, a review of the more general aspects common to many of the embodiments of the present invention can be understood with reference to FIGS. 4-6. FIG. 4 is a block diagram depiction of a network node 400 in accordance with various embodiments of the present invention.

Network node 400 includes processing unit 401 and interface unit 410, which includes network interface 411 for communication with other network devices. In some embodiments, but not all, network node 400 also includes wireless transceiver 412. For example, in some embodiments network node 400 may comprise a network device that does not include a wireless transceiver, while in other embodiments network node 400 may comprise a wireless transceiver node, such as a base station or 3GPP LTE eNodeB.

Those skilled in the art will recognize that the depiction of network node 400 in FIG. 4 does not show all of the components necessary to operate in a commercial communications system but only those components and logical entities particularly relevant to the description of embodiments herein. For example, network nodes are known to comprise processing units, network interfaces, and wireless transceivers. In general, such components are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, network node 400, for example, represents known devices that have been adapted, in accordance with the description herein, to implement multiple embodiments of the present invention. Furthermore, those skilled in the art will recognize that aspects of the present invention may be implemented in and/or across various physical components and none are necessarily limited to single platform implementations.

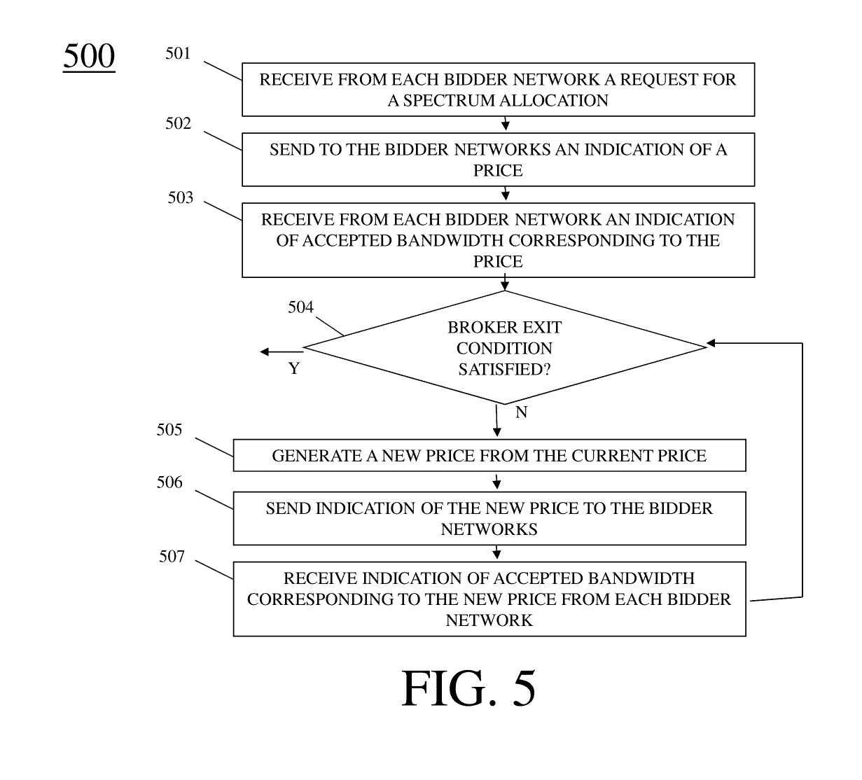

Aspects of embodiments of the present invention can be understood with reference to FIG. 5. Diagram 500 of FIG. 5 is a logic flow diagram of functionality performed by a broker network in accordance with various embodiments of the present invention. In most embodiments, a network node such as network node 400 performs the broker network functionality depicted in logic flow diagram 500.

In the method depicted in diagram 500, a broker network receives (501) from each bidder network of a group of bidder networks, a request for a spectrum allocation. The broker network sends (502) to the group of bidder networks an indication of a price and receives (503) from each bidder network an indication of accepted bandwidth corresponding to the price. Until (504) a broker exit condition is satisfied, the broker network iteratively performs the following: generates (505) a new price from the current price, sends (506) an indication of the new price to the group of bidder networks, and receives (507) an indication of accepted bandwidth corresponding to the new price from each bidder network of the group of bidder networks.

In many embodiments, generating the new price from the current price involves calculating the new price using the current price, the accepted bandwidth as indicated by each bidder network of the group of bidder networks, a total amount of bandwidth available for bidding, and a step size. In some embodiments, the broker network may add an additional bidder network to the group of bidder networks, possibly even after beginning the iterations with the group of bidder networks.

In many embodiments the broker exit condition is satisfied when the broker network determines that a broker utility function is sufficiently maximized, the broker utility function being a function of the accepted bandwidth as indicated by each bidder network of the group of bidder networks. Depending on the embodiment, the broker utility function may be set to total revenue generated. In many embodiments, the broker exit condition may additionally (or alternatively) be satisfied when the broker network determines that a maximum number of iterations has occurred or a maximum amount of time has elapsed.

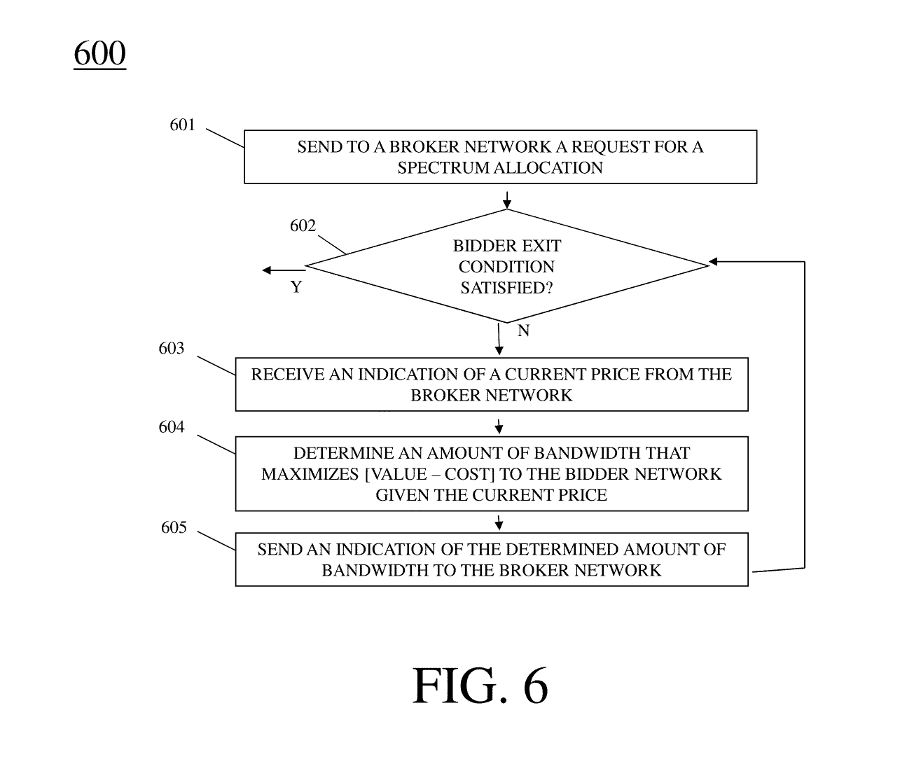

Diagram 600 of FIG. 6 is a logic flow diagram of functionality performed by a bidder network in accordance with various embodiments of the present invention. In most embodiments, a network node such as network node 400 performs the bidder network functionality depicted in logic flow diagram 600.

In the method depicted in diagram 600, a bidder network sends (601) to a broker network, a request for a spectrum allocation. In many embodiments this request indicates an amount of bandwidth for which the bidder network desires to bid. Until (602) a bidder exit condition is satisfied, the bidder network iteratively performs the following: receives (603) an indication of a current price from the broker network, determines (604) an amount of bandwidth that maximizes [value cost] to the bidder network given the current price, and sends (605) an indication of the determined amount of bandwidth to the broker network.

In many embodiments, determining the amount of bandwidth that maximizes [value cost] to the bidder network given the current price involves using a utility function to calculate value, the utility function being a function of an amount of bandwidth. In some embodiments, using a utility function to calculate value may involve using a different utility function for some iterations than is used for other iterations. Also, in some embodiments, the bidder network may switch to a different utility function based on a traffic demand level at the bidder network.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method comprising:
receiving, by a broker network from each bidder network of a group of bidder networks, a request for a spectrum allocation;
sending, by the broker network to the group of bidder networks, a current price of bandwidth;
receiving, by the broker network from each bidder network of the group of bidder networks, an indication of a determined amout of accepted bandwidth corresponding to the current price;
until a broker exit condition is satisfied, iteratively performing by the broker network the steps comprising:
generating a new price from (i) the current price and (ii) the determined amounts of accepted bandwidth for the group of bidder networks,
sending the new price to the group of bidder networks, and
receiving an indication of a determined amount of accepted bandwidth corresponding to the new price from each bidder network of the group of bidder networks.

2. The method as recited in claim 1, wherein the broker exit condition is satisfied when the broker network determines that a broker utility function is sufficiently maximized, the broker utility function being a function of the determined amount of accepted bandwidth as indicated by each bidder network of the group of bidder networks.

3. The method as recited in claim 2, wherein the broker utility function is set to total revenue generated.

4. The method as recited in claim 1, wherein the broker exit condition is satisfied when the broker network determines that at least one of a threshold number of iterations has occurred or a threshold amount of time has elapsed.

5. The method as recited in claim 1, wherein generating the new price from the current price comprises
calculating the new price using the current price, the determined amount of accepted bandwidth as indicated by each bidder network of the group of bidder networks, a total amount of bandwidth available for bidding, and a step size.

6. The method as recited in claim 1, further comprising
adding, by the broker network, an additional bidder network to the group of bidder networks, after beginning the iteration with the group of bidder networks.

7. An article of manufacture comprising a non-transitory processor-readable storage medium storing one or more software programs which when executed by one or more processors performs the steps of the method of claim 1.

8. A method comprising:
sending, by a bidder network to a broker network, a request for a spectrum allocation;
until a bidder exit condition is satisfied, iteratively performing by the bidder network the steps comprising:
receiving a current price for bandwidth from the broker network,
determining an amount of accepted bandwidth that maximizes [value−cost] to the bidder network based on the current price, and
sending an indication of the determined amount of accepted bandwidth to the broker network.

9. The method as recited in claim 8, wherein the request for a spectrum allocation indicates an amount of bandwidth for which the bidder network desires to bid.

10. The method as recited in claim 8, wherein determining the amount of accepted bandwidth that maximizes [value−cost] to the bidder network based on the current price comprises
using a utility function to calculate value, the utility function being a function of an amount of bandwidth.

11. The method as recited in claim 10, wherein using a utility function to calculate value comprises
using a different utility function for some iterations than is used for other iterations.

12. The method as recited in claim 10, further comprising
switching to a different utility function based on a traffic demand level at the bidder network.

13. An article of manufacture comprising a non-transitory processor-readable storage medium storing one or more software programs which when executed by one or more processors performs the steps of the method of claim 8.

14. A network node in a broker network, the network node comprising:
an interface comprising a network interface for communication with other network devices;
a processor, communicatively coupled to the interface, configured
to receive, via the interface from each bidder network of a group of bidder networks, a request for a spectrum allocation,
to send, to the group of bidder networks via the interface, a current price for bandwidth,
to receive, via the interface from each bidder network of the group of bidder networks, an indication of a determined amount of accepted bandwidth corresponding to the current price, and
to iteratively perform, until a broker exit condition is satisfied,
generating a new price from (i) the current price and the determined amounts of accepted bandwidth for the group of bidder networks,
sending via the interface an indication of the new price to the group of bidder networks, and
receiving via the interface an indication of a determined amount of accepted bandwidth corresponding to the new price from each bidder network of the group of bidder networks.

15. The network node as recited in claim 14,
wherein the network node in the broker network further comprises a wireless transceiver node and
wherein at least some of the communication with the group of bidder networks occurs via the wireless transceiver node.

16. A network node in a bidder network, the network node comprising:
an interface comprising a network interface for communication with other network devices;
a processor, communicatively coupled to the interface, configured
to send, to a broker network via the interface, a request for a spectrum allocation,
to iteratively perform, until a bidder exit condition is satisfied,
receiving a current price for bandwidth from the broker network via the interface,
determining an amount of accepted bandwidth that maximizes [value−cost] to the bidder network based on the current price, and
sending an indication of the determined amount of accepted bandwidth to the broker network via the interface.

17. The network node as recited in claim 16,
wherein the network node in the bidder network comprises a wireless transceiver node and
wherein at least some of the communication with the broker network occurs via the wireless transceiver node.

18. The network node of claim 16, wherein:
for each iteration, the determined amount of accepted bandwidth can vary from bidder network to bidder network; and
from iteration to iteration, the new price can vary and the determined amount of accepted bandwidth for each bidder network can vary.

19. The method of claim 1, wherein:
for each iteration, the determined amount of accepted bandwidth can vary from bidder network to bidder network; and
from iteration to iteration, the new price can vary and the determined amount of accepted bandwidth for each bidder network can vary.

20. The method of claim 8, wherein:
for each iteration, the determined amount of accepted bandwidth can vary from bidder network to bidder network; and
from iteration to iteration, the new price can vary and the determined amount of accepted bandwidth for each bidder network can vary.

21. The network node of claim 14, wherein:
for each iteration, the determined amount of accepted bandwidth can vary from bidder network to bidder network; and
from iteration to iteration, the new price can vary and the determined amount of accepted bandwidth for each bidder network can vary.
